(19) United States
(12) Patent Application Publication
(10) Pub. No.: US 2009/0294586 A1
(43) Pub. Date: Dec. 3, 2009

(54) Facility structures for commercial passenger aircraft

(76) Inventors: Warwick Brown, Christchurch (NZ); Glen Porter, Christchurch (NZ); Darryl James Gibson, Christchurch (NZ); John Reuben Thomson, Christchurch (NZ)

Correspondence Address: JACOBSON HOLMAN PLLC, 400 SEVENTH STREET N.W., SUITE 600, WASHINGTON, DC, 20004, US

(21) Appl. No.: 11/921,024

(22) PCT Filed: May 25, 2006
(86) PCT No.: PCT/NZ2006/000129

§ 371 Date: Jun. 22, 2009

Related U.S. Application Data
(60) Provisional application No. 60/684,934, filed on May 25, 2005.

(51) Int. Cl. B64D 11/00

(52) U.S. Cl. 244/118.5

(57) ABSTRACT

A facility structure (1) for an aircraft, manufactured form at least one monocoque structural component (6) of a composite construction.

### FIELD OF THE INVENTION

The present invention relates to improved facility structures for commercial passenger aircraft.

### BACKGROUND

In the cabin area of commercial passenger aircraft there are usually kitchens, cloak or coat lockers, toilet cubicles and the like.

The design and construction of such facility structures is complex and can be time consuming. Facility structures traditionally have been manufactured by firstly defining a space frame structure of an aluminium framework to which cladding or panelling is affixed by suitable fasteners.

Typically the space frame bolts down either to a base or directly onto the seat rails or similar of the cabin floor.

This frame is skinned by cladding material to create an enclosed structure. Utilities and shelves and other features may be built onto the frame or hung there from. Typically prior art furniture structures are assembled piece by piece and usually within the aircraft.

The construction of fabricated facility structures, whilst utilising predominantly light weight material such as aluminium, may use heavier metal alloys for areas requiring higher strength.

Creating a fabricated facility structure is time consuming. Furthermore such facility structures are also of a relatively heavy weight. This may be because of the need to use strengthening components that do not need to be of a larger than required size for strengthening, other than for connecting such components to parts of the space frame. It may also be due to the need to include components or features to allow fastening to other features or components. Also, fasteners to connect the components together add weight. This may contribute to the overall weight of the facility structures being beyond that which is there to provide the purely functional aspects of the facility structures, at a weight not significantly greater than is necessary to provide the facility structures of a strength to meet civil aviation or OEM rules and that is also of an aesthetic appearance.

In the aircraft industry significant savings can be made in operation costs if the material weight of structures within an aircraft can be reduced. The reduction of weight is one of the main driving factors for research and manufacture in the aircraft industry.

Heavier facility structures are by virtue of their own weight, also subjected to higher dynamic loading requiring greater inherent strength as well as reinforcing or more complex design at their mounting. Typically such facility structures must be able to survive a 9G loading by remaining structurally intact to ensure the safety of the occupants of the aircraft.

Thus there is further advantage in reducing the weight of facility structure type structures that is not just one directly reducing the total weight of the aircraft but also one reducing dynamic load requirements of the facility structures and of their bearing on those parts of the aircraft to which the facility structures is engaged.

It is therefore an objective of the present invention to provide an improved facility structures for an aircraft which at least goes someway to overcoming the above disadvantages or to meet at least some of the abovementioned desiderata or which will at least provide the public with a useful choice.

In a first aspect the present invention consists in a facility structure for an aircraft, manufactured from at least one monocoque structural component of a composite construction.

Preferably said monocoque structural component defines a partition that has at least two non parallel wall sections.

Preferably said monocoque structural component defines a partition that has at least three non parallel wall sections.

Preferably said wall sections are substantially vertically extending upright wall sections.

Preferably said monocoque structural component also defines, extending between said non parallel wall sections, a floor.

Preferably said monocoque structural component defines a floor, and at least one vertically extending wall section upstanding from at least one perimeter region of said floor.

Preferably said wall sections define an enclosed perimeter to said facility structure save for any one or more opening provided at the two opposed ends of said monocoque structural component.

Preferably said wall section and said floor define an enclosure save for any one or more opening provided at the ceiling and opening generated in the said monocoque structural component.

Preferably extending between said non parallel wall sections there is provided a floor.

Preferably each said wall section and said floor define an enclosure save for any openings provided at the ceiling and openings generated in the said monocoque structure.

Preferably said monocoque structural component is defined from a monocoque precursor of a constant cross sectional shape over its length.

Preferably said monocoque structural component is defined from a monocoque precursor of a constant cross sectional shape over its length and wherein said cross section defines an enclosed region.

Preferably said monocoque structural component is defined by said precursor and that has been modified to remove sections from at least one of said wall sections.

Preferably provided through at least one of said wall sections there is at least one closable opening.

Preferably said closable opening is closable by a hatch or door.

Preferably said hatch or door is defined by a section of said monocoque structural component removed to define said opening.

Preferably said floor includes a mounting wherein said facility structure can be mounted to a structure of said aircraft by said mounting.

Preferably said floor is continuous intermediate of said wall sections.

Preferably a ceiling panel is provided.

Preferably said ceiling panel is presented to define an external or said facility structure presented working surface.

Preferably said wall sections define an openable enclosure.

Preferably a further wall section is provided, projecting freely from one of said wall sections defining an openable closure.

Preferably removable shrouding is located above and supported by said wall sections to extend between said wall sections and the inwardly presented cabin lining surface(s) of said aircraft.

Preferably said removable shrouding has an externally presented surface that is parallel the externally presented surfaces of sail wall section.

Preferably said composite material is of a sandwich structure.

Preferably said sandwich structure consists of a core captured intermediate of at least one ply of resin re-enforced fibre on each side of said core.

Preferably said core is of a foam sheet material.

Preferably said core is of a honeycomb sheet material.

Preferably said facility structure is configured to define a facility selected from any one of (a) toilet and (b) a galley cabinet and (c) a coat locker and (d) storage locker and (e) a crew rest enclosure.

In a further aspect the present invention consists in a facility structure for aircraft having been manufactured from a monocoque precursor of a composite construction and of a constant cross sectional shape.

In a further aspect the present invention consists in a method of manufacturing a facility structure including the steps of

a. taking a monocoque precursor partition structure of a composite construction and of a constant cross sectional shape that defines and enclosed area, and

b. removing a region of said partition structure to create an opening through said partition structure.

Preferably said region of said partition structure removed is used to manufacture a closure for said opening.

Preferably said region of said partition structure removed defines an opening through said partition structure with a perimeter defined entirely by said partition structure.

In a further aspect the present invention consists in an aircraft including a facility structure as herein described.

In a further aspect the present invention consists in a facility structure as herein described and with reference to any one of the accompanying drawings.

In a further aspect the present invention consists in a facility structure as described above and as herein described with reference to any one of the accompanying drawings.

In a further aspect the present invention consists in a facility structure as shown in any one of the accompanying drawings.

In a further aspect the present invention consists in a facility structure for an aircraft, the facility structure having been manufactured from a monocoque composite structure.

In a further aspect the present invention consists in a facility structure for an aircraft defined by wall sections extending about at least two faces of the facility structure and made from a composite material.

In a further aspect the present invention consists in an aircraft facility structure for the internal cabin area of an aircraft the structure defining an enclosed space partion formed from at least one composite monocoque precursor that is of a constant cross-section at any given plane taken through said precursor that is perpendicular to at least one orthogonal axes.

Preferably said precursor is modified to introduce an opening to the enclosure defined by said structure.

Preferably it is used to define at least one of a galley (whether wet or dry), wardrobe, closet, cupboard, storage area, water closet and crew rest.

Preferably the facility structure is for use onboard a commercial passenger aircraft.

Preferably said composite monocoque component is of a composite sandwich construction.

Preferably the sandwich construction consists of at least one layer of a core material selected from one of (a) a foam material and (b) a honeycomb material, that is sandwiched intermediate of two layers each of a resin reinforced fibre material.

In a further aspect the present invention consists in a facility structure for an aircraft, manufactured from at least one monocoque structure of a composite sandwich construction.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred embodiments of the present invention will now be described with reference to the accompanying drawings whereby

FIG. 1(a) shows a composite monocoque structure precursor prior to its manufacture into a composite monocoque facility structure,

FIG. 1(b) shows a composite monocoque structure after it has undergone cutting out of door apertures and machining of mounting points, the material cut out capable of being finished to doors for the apertures,

FIG. 1(c) is a cross sectional view of a facility structure wherein the wall structure of the facility structure is defined by seven monocoque composite components,

FIG. 2 shows a top down isometric view of a composite monocoque facility structure in its finished form after manufacture from a composite monocoque structure precursor, and showing the cut outs for doors and cupboards that are cut from the original composite monocoque structure precursor,

FIG. 3 is an isometric view of a number of composite monocoque facility structures assembled together and defining a bar, table, cupboard and storage areas,

FIG. 4 shows a cupboard facility structure in isometric at FIG. 4(a), plan view in FIG. 4(b), and end view in FIG. 4(c) and cross-sectional view in FIG. 4(d) along line AA of 4(c),

FIG. 5 shows a lowered cupboard facility structure in isometric at FIG. 5(a), plan view in FIG. 5(b), and end view in FIG. 5(c) and a side view in FIG. 5(d),

FIG. 6A shows an end view of a further facility structure, and

FIG. 6B shows a plan cross sectional view along line AA of FIG. 6A.

### DETAILED DESCRIPTION OF THE INVENTION

Where reference herein is made to a monocoque structure or monocoque precursor, it is to be understood to have its traditional meaning and including but not limited to a structure made from a single structural component. It may also include a structure that is defined from one or more monocoque components that are bonded together to define an integral facility structure.

Where reference herein is made to a composite construction, it is to be appreciated that such may include a multi-ply or multilayered assembly of materials each layer or ply of which may be of a different material or some of which may be different materials or some or all of which may have a different property or offer different characteristics.

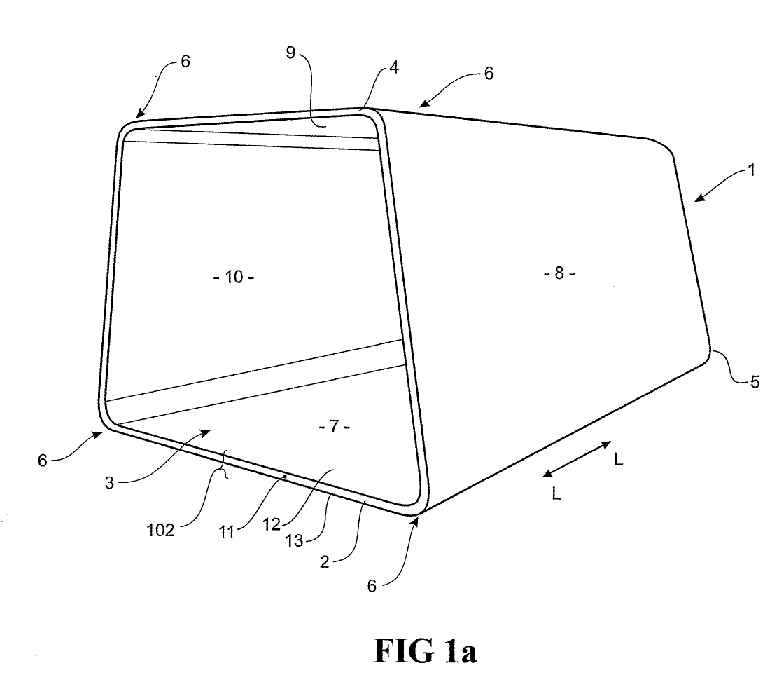

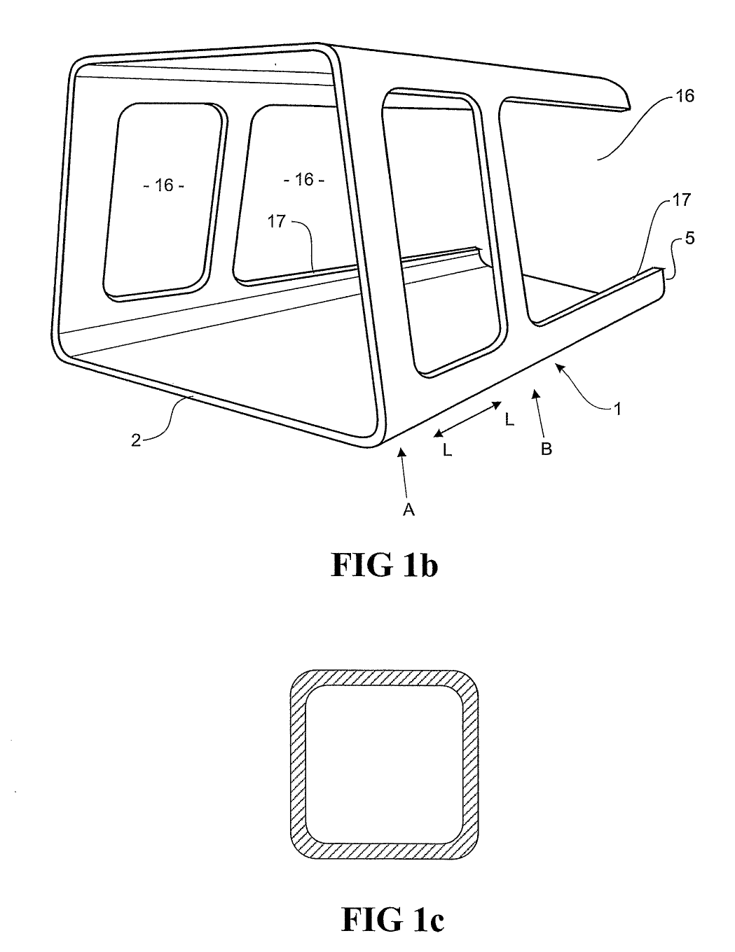

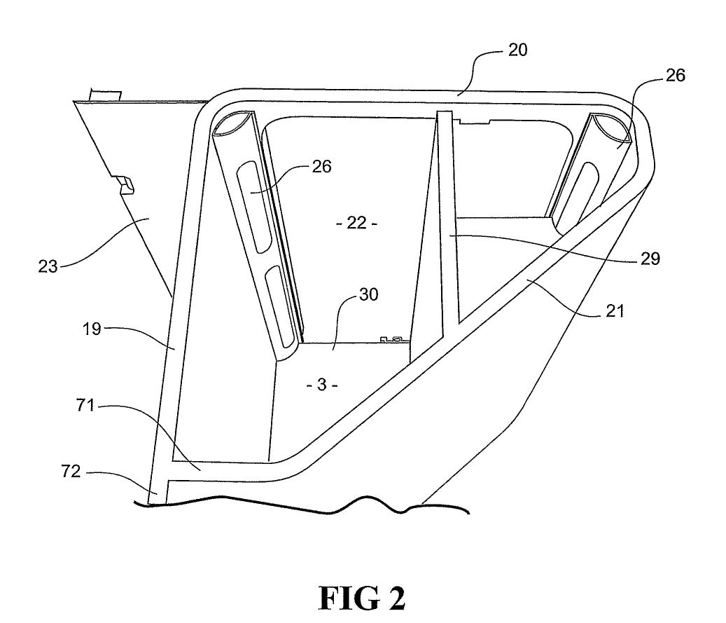

With reference to FIG. 1 there is shown a composite structure precursor 1. The composite structure precursor 1 preferably consists of a sheet like material 102 of a composite construction. The sheet like material 102 of composite construction defines a perimeter to an enclosure 3. The composite structure precursor 1 is along its longitudinal direction LL defined by a wall structure 2 that is of a shape and of a size and configuration that is of a substantially constant cross section. In other words no matter where a slice is taken through the composite structure precursor 1 in a direction transverse to the longitudinal direction LL, the same cross sectional shape will be defined. The length (being the distance between the first and second end surfaces 4, 5 of the composite structure precursor) is preferably constant and is of a length suitable for the purposes to which the composite structure precursor is to be put for subsequent manufacturing into a facility structure.

In one mode of the present invention, the composite structure precursor is defined by the wall 2 which is preferably of a constant thickness and preferably of constant cross-section except potentially for additionally enforcing which might be created at or along corner regions 6. The composite structure precursor is one monocoque structure defining wall sections 7, 8, 9, 10 that are each integrally formed with each other to define a perimeter about the enclosure 3. Alternatively the composite structure precursor is made up of several monocoque components that are bonded together to define the composite structure or composite structure precursor as shown in FIG. 1(c).

The wall 2 of the composite structure precursor preferably consists of a core 11 that is captured between an inner and outer skin 12, 13 respectively. The inner and outer skin 12, 13 are preferably fibre reinforced resin plies of material that provide suitable strength and other characteristic properties such as inpermeability to water and/or air, strength against bending and shear and compression and the like.

The core 11 is preferably of a honeycomb material but may alternatively be of a foam material. Whilst preferably there is a mere single core material provided, the core may consist of a lamination of multiple sheets of material captured within the skins 12 and 13. The honeycomb core 11 may preferably be of a constant configuration or it may alternatively be of a varying density or configuration such as for example by having a higher density honeycomb at and along the corner regions 6. Indeed whilst the core material may be defined by a single sheet of material formed to the appropriate shape, the core may be made from a plurality of sheets that are pre formed and bonded together to define the shape as for example shown in FIG. 1(c).

A facility structure of the present invention is formed from a composite structure precursor 1 as shown in FIG. 1(a) that is formed as a single monocoque structure or made up of several monocoque structural components by the steps including the removal of regions of the wall 2 to define cut-outs or openings as for example shown in FIG. 1(b). In FIG. 1(b) a composite structure precursor 1 has had openings or apertures 16 defined by a cutting through the wall 2. The openings are created in predefined locations to correspond to regions where openings, rebates, recesses or access passages are to be provided through the wall structure 2 of the composite structure precursor 1. Accordingly, save for any top opening and any other wall openings that are provided, the wall defines a partition to an enclosed space.

The openings 16 may be provided as holes through the wall structure 2 or may be provided as cut-ins from on or both of the a distal ends 5 and 6 of the composite structure precursor 1.

Appropriate manufacturing techniques, including the aid of computer aided design and cutting, may be utilised for the purposes of creating the cutaways from the wall structure 2. A trimming of the exposed edges 17 of the openings 16 may occur to conceal the then exposed core 11 of the wall structure 2. Trim may come in the form of a capping that is affixed to the structure or by the use of a resinous material including any fibre reinforced material that may be engaged to the edges so exposed as a result of removal of the cut-outs or openings in the structure. The structure defined from the precursor and as for example shown in FIG. 1(b) is no longer of a constant cross section along its length LL as a result of the cutting away of the cut-outs, but may remain of a constant cross section along certain portions extending in the direction LL. Indeed at certain regions, such as regions A and B, being regions lying in a plane transverse to the direction LL, the structure 1 still defines a perimeter that is continuous in a given horizontal plane. A trimming of the upper and lower exposed edges at the distal ends 5 and 6 may also occur to conceal the honeycomb core material.

The cut-outs removed from the wall structure 2 can be utilised for defining closures that can be reinserted into the openings to allow for the openings to be closeable by such closures. For example doors or hatches may be manufactured from the wall structures 2 cut out to define the openings 16 to then be reutilised for providing closures to such openings.

The facility structures of the present invention are utilised preferably in an orientation such that the longitudinal direction LL extends substantially vertically.

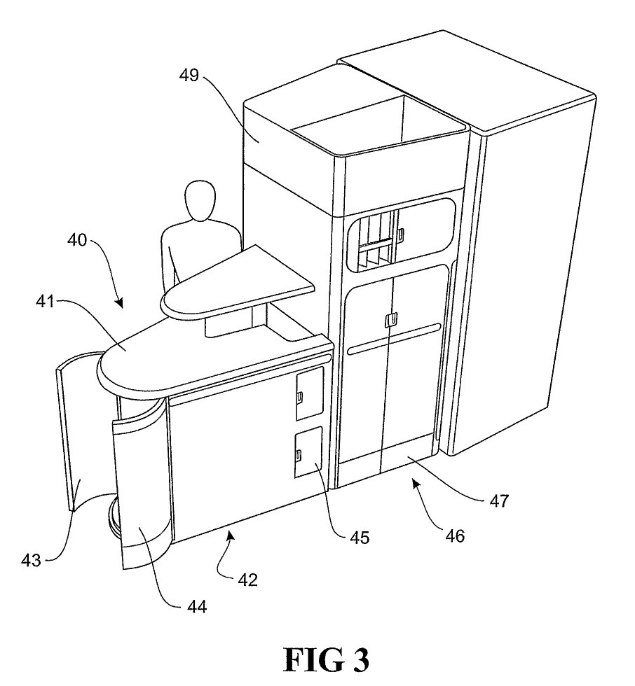

Therefore the walls 7, 8, 9, 10 preferably also extend in a substantially vertical direction. The structure defined as for example shown in FIG. 1(b), can then have additional componentry added to it for the purposes of defining a facility suitable for use within the aircraft. For example with reference to FIG. 2 there is shown a storage compartment having an enclosed region 3 defined within the perimeters of the walls 19, 20 and 21 including an opening 22 closeable by a closure 23. The closure 23 has been manufactured from the portion cut away from the wall 20. Utility ducting 26 may be incorporated for the provision of utilities within or passing through the facility structures. Such utilities may for example include electricity, lighting, water, gas and the like. Additional partitions 29 may also be included within the structure and such may be engaged to the structure by the use of adhesive affixing or by the use of mechanical fastening means. The structure precursor may also have engaged therewith by adhesive affixing and/or by mechanical fastening, a floor 30. The floor 30 is preferably provided at the lower distal most end of the structure and provides a base to the structure. The floor may be coextensive with the perimeter of the wall structure defined by the walls 19, 20 and 21 or may only be partially extensive within the perimeter defined by such walls. In the most preferred form the floor 30 includes mounts which allow for the facility structure to be affixed directly to the appropriate structure of the plane such as the seat mounting rails of a plane. No intermediate frame or base is required. The floor, once assembled with the structure will form an integral part of the facility structures, allowing for the facility structure to be directly mounted to the seat mounting rails without the need for any intermediate plinth or the like.

The closures such as the door 23, can be manufactured to snugly fit within the openings like the opening 22 to provide suitable closure for the purposes as required.

One of the advantages of a composite monocoque construction of a facility structure is the ability for the facility structure to include rounded corners that define the transition between adjacent flat wall sections of the facility structure and to provide a facility structure where some or all the wall to the enclosed space are non-planar. Additionally the facility structure can to a large extent be manufactured without significant fabrication being required. The structural components of the facility structures are preferably defined in a monocoque form or defined from monocoque components adhesively affixed to each other to define an integral structural component. Accordingly as well as defining a partitioning surface to the enclosed space the monocoque structure provides the primary structural strength of the structure.

FIG. 3 illustrates a perspective view of a plurality of facility structures made having been juxtaposed each other to provide the desired functionality and utilities. The facility structure 40 may for example be a servery or bar or similar wherein the facility structure has provided thereon a working surface 41. The facility structure 42 defines an enclosure which is openable by the doors 43 and 44 and may also include access openings or hatches 45. The facility structure 46 shown in FIG. 3 includes a bi-fold door 47 and carries on top thereof a shroud defining element or construction 49. The shrouding 49 sits on top of the facility structure and can provide a continuation of the perimeter form of the facility structure 46 extending towards the ceiling of the internal cabin space of an aircraft. Where a facility structure is to be relocated to a different position within an aircraft, a different shrouding can be mounted on top of the facility structure such different shrouding providing a shape to be complimentary to the internal sealing of the aircraft at such a new location to provide a neat and tidy trimming of the facility structure with its surrounds.

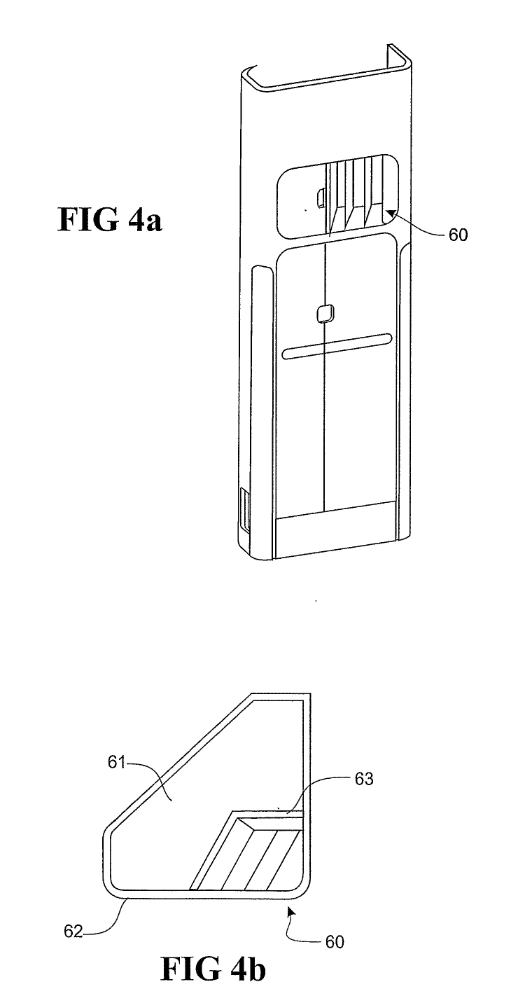

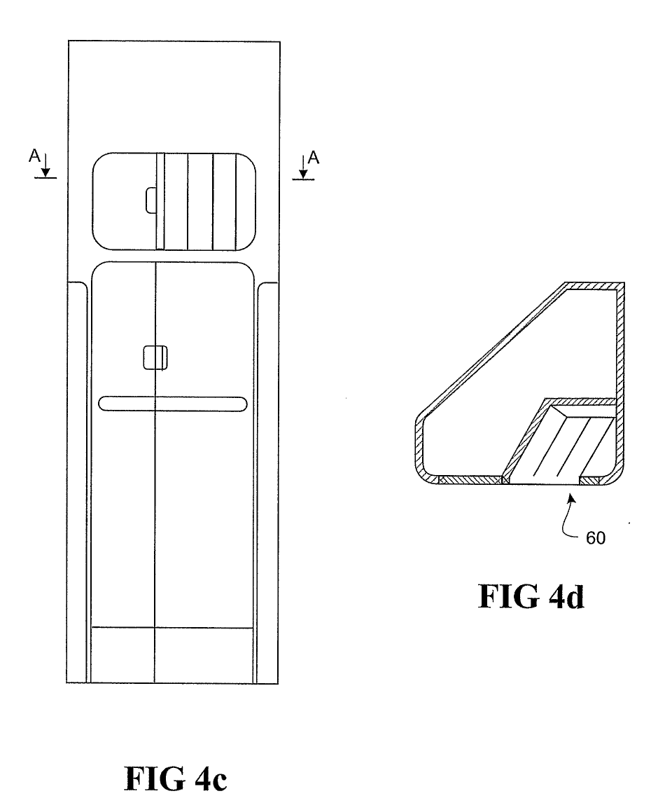

With reference to FIG. 4 there is shown a facility structure that may include for example a magazine storage rack 60 and a coat cupboard 61. Again a composite structure 62 is defined in which cut outs are formed and internal partitioning such as partitioning 63 is provided.

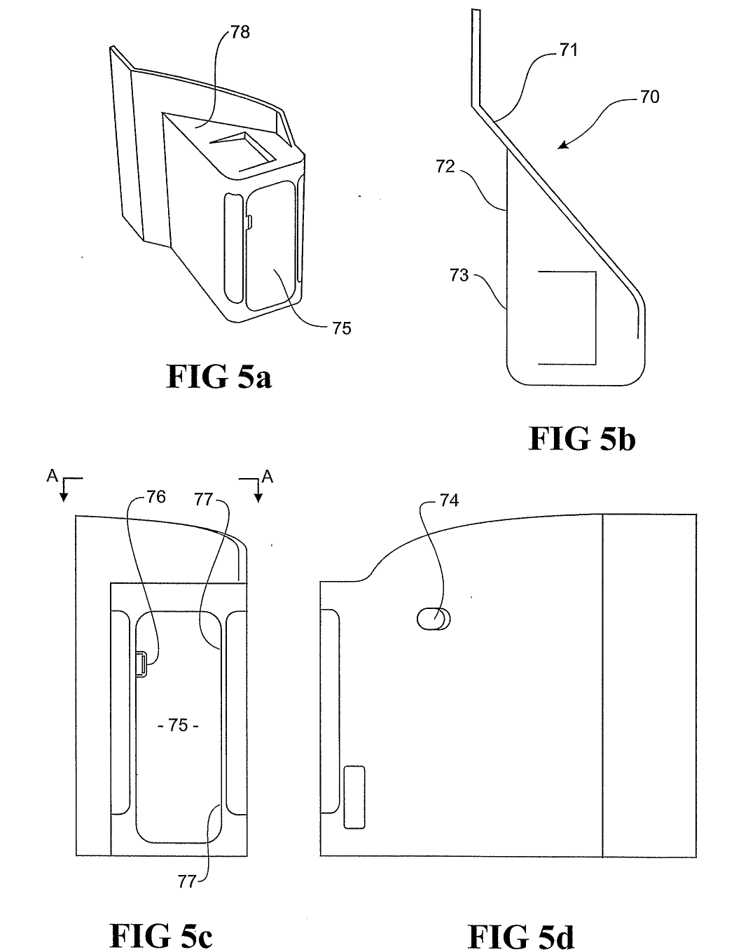

With reference to FIG. 5 there is shown a further embodiment of a lowered cupboard facility structure 70. The facility structure 70 is manufactured from a precursor similar to the form shown in FIG. 2. A composite structure 73 is defined in which cut outs are formed into for example a door 75 which is hinged 77 to the facility structure 70 and held closed by a latch/catch 76. Other cut outs 74 are provided for hand holds and/or access as required. A working surface 78 is also provided.

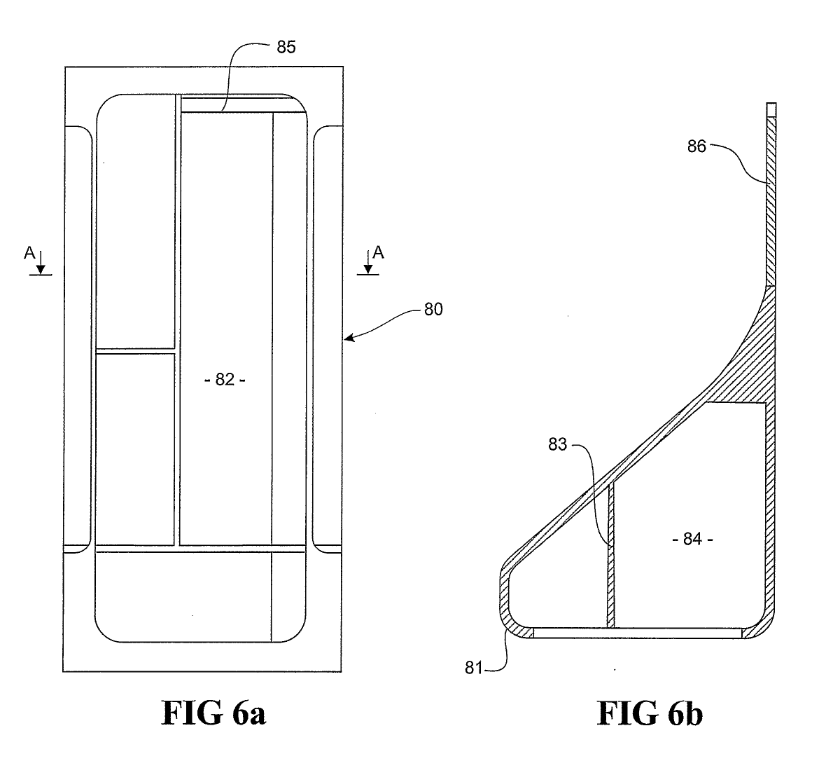

With reference to FIG. 6 there is shown a tall cupboard 80. The cupboard is defined from a similar composite precursor form as that of FIG. 5. Reinforcing or trim 81 may be applied to corners where required. The cupboard 80 has cut outs to define a door aperture 82, which may or may not be able to be closed by a door. Partitioning 83 is provided to define smaller shelved spaces distinct from the main enclosed space 84. A coat rack 85 may be provided also. This cupboard 80 is typical of a form of the invention in that a wall 86 juts out from the enclosure to form an external partition or wall. The enclosure of the cupboard may be formed in a similar way by the juxtaposing of walls.

The invention therefore provides a facility structure of a composite construction where the facility structure can be constructed of continuous cross section composite panel only (i.e. no metallic structural members are necessary to reinforce the facility structure against its own load). Metallic structural members are only needed where for example a composite panel has been cut away, i.e. door openings, and where the facility structure attaches to the aircraft itself.

1: A facility structure for an aircraft, manufactured from at least one monocoque structural component of a composite construction.

2. The facility structure as claimed in claim 1 wherein said monocoque structural component defines a partition that has at least two non parallel wall sections.

3. The facility structure as claimed in claim 1 wherein said monocoque structural component defines a partition that has at least three non parallel wall sections.

4. The facility structure as claimed in claim 2 wherein said wall sections are substantially vertically extending upright wall sections.

5. A The facility structure as claimed in claim 2 wherein said monocoque structural component also defines, extending between said non parallel wall sections, a floor.

6. The facility structure as claimed in claim 1 wherein said monocoque structural component defines a floor, and at least one vertically extending wall section upstanding from at least one perimeter region of said floor.

7. The facility structure as claimed in claim 2 wherein said wall sections define an enclosed perimeter to said facility structure save for any one or more opening provided at the two opposed ends of said monocoque structural component.

8. The facility structure as claimed in claim 5 wherein said wall section and said floor define an enclosure save for any one or more opening provided at the ceiling and opening generated in the said monocoque structural component.

9. A The facility structure as claimed in claim 2 wherein extending between said non parallel wall sections there is provided a floor.

10. The facility structure as claimed in claim 9 wherein each said wall section and said floor define an enclosure save for any openings provided at the ceiling and openings generated in the said monocoque structure.

11. The facility structure as claimed claim 1 wherein said monocoque structural component is defined from a monocoque precursor of a constant cross sectional shape over its length.

12. A The facility structure as claimed in claim 1 wherein said monocoque structural component is defined from a monocoque precursor of a constant cross sectional shape over its length and wherein said cross section defines an enclosed region.

13. The facility structure as claimed in claim 11 wherein said monocoque structural component is defined by said precursor and that has been modified to remove sections from at least one of said wall sections.

14. The facility structure as claimed in claim 2 wherein provided through at least one of said wall sections there is at least one closable opening.

15. The facility structure as claimed in claim 14 wherein said closable opening is closable by a hatch or door.

16. The facility structure as claimed in 15 wherein said hatch or door is defined by a section of said monocoque structural component removed to define said opening.

17. The facility structure as claimed in claim 5 wherein said floor includes a mounting wherein said facility structure can be mounted to a structure of said aircraft by said mounting.

18. The facility structure as claimed in claim 16 wherein said floor is continuous intermediate of said wall sections.

19. The facility structure as claimed in claim 1 wherein a ceiling panel is provided.

20. The facility structure as claimed in claim 19 wherein said ceiling panel is presented to define an external or said facility structure presented working surface.

21. The facility structure as claimed in claim 1 wherein said wall sections define an openable enclosure.

22. The facility structure as claimed in claim 21 wherein a further wall section is provided, projecting freely from one of said wall sections defining an openable closure.

23. The facility structure as claimed in claim 1 wherein removable shrouding is located above and supported by said wall sections to extend between said wall sections and the inwardly presented cabin lining surface(s) of said aircraft.

24. The facility structure as claimed in claim 23 wherein said removable shrouding has an externally presented surface that is parallel the externally presented surfaces of sail wall section.

25. The facility structure as claimed in claim 1 wherein said composite material is of a sandwich structure.

26. The facility structure as claimed in claim 25 wherein said sandwich structure consists of a core captured intermediate of at least one ply of resin re-enforced fibre on each side of said core.

27. The facility structure as claimed in claim 26 wherein said core is of a foam sheet material.

28. The facility structure as claimed in claim 26 wherein said core is of a honeycomb sheet material.

29. The facility structure as claimed in claim 1 configured to define a facility selected from any one of (a) toilet and (b) a galley cabinet and (c) a coat locker and (d) storage locker and (e) a crew rest enclosure.

30. A facility structure for aircraft having been manufactured from a monocoque precursor of a composite construction and of a constant cross sectional shape.

31. A method of manufacturing a facility structure including the steps of
a. taking a monocoque precursor partition structure of a composite construction and of a constant cross sectional shape that defines and enclosed area, and
b. removing a region of said partition structure to create an opening through said partition structure.

32. The method as claimed in claim 31 wherein said region of said partition structure removed is used to manufacture a closure for said opening.

33. The method as claimed in claim 32 wherein said region of said partition structure removed defines an opening through said partition structure with a perimeter defined entirely by said partition structure.

34. The aircraft including a facility structure as claimed in claim 1.

35. (canceled)

36. The facility structure as claimed in claim 1 and as herein described with reference to any one of the accompanying drawings.

37. (canceled)

38. A facility structure for an aircraft, the facility structure having been manufactured from a monocoque composite structure.

39. A facility structure for an aircraft defined by wall sections extending about at least two faces of the facility structure and made from a composite material.

40. An aircraft facility structure for the internal cabin area of an aircraft the structure defining an enclosed space partion formed from at least one composite monocoque precursor that is of a constant cross-section at any given plane taken through said precursor that is perpendicular to at least one orthogonal axes.

41. The aircraft facility structure as claimed in claim 40 wherein said precursor is modified to introduce an opening to the enclosure defined by said structure.

42. The aircraft facility structure as claimed in claim 40 wherein it is used to define at least one of a galley (whether wet or dry), wardrobe, closet, cupboard, storage area, water closet and crew rest.

43. The facility structure as claimed in claim 1 wherein the facility structure is for use onboard a commercial passenger aircraft.

44. The facility structure as claimed in claim 1 wherein said composite monocoque component is of a composite sandwich construction.

45. The facility structure as claimed in claim 44 wherein the sandwich construction consists of at least one layer of a core material selected from one of (a) a foam material and (b) a honeycomb material, that is sandwiched intermediate of two layers each of a resin reinforced fibre material.

46. facility structure for an aircraft, manufactured from at least one monocoque structure of a composite sandwich construction.
